(19) United States
(12) Patent Application Publication
(10) Pub. No.: US 2012/0141907 A1
(43) Pub. Date: Jun. 7, 2012

(54) FUEL CELL MEMBRANE ELECTRODE ASSEMBLY

(75) Inventors: SYED MOHAMMED JAVAID ZAIDI, DHAHRAN (SA); SALEEM UR RAHMAN, DHAHRAN (SA); SHAKEEL AHMED, DHAHRAN (SA); MUKHTAR BELLO, ZARIA (NG)

(73) Assignee: KING FAHD UNIVERSITY OF PETROLEUM AND MINERALS, DHAHRAN (SA)

(21) Appl. No.: 13/342,919

(22) Filed: Jan. 3, 2012

(51) Int. Cl. H01M 4/92; H01M 8/10

(52) U.S. Cl. 429/480; 429/524

(57) ABSTRACT

The fuel cell membrane electrode assembly includes PtRu active species supported on mesoporous carbon nitride materials for use in the anode of direct methanol fuel cells. The fuel cell membrane electrode assembly includes an anode plate, a gas diffusion layer, and a catalyst adjacent a PEM membrane. The composition of the catalyst is about 30 wt % active species and 70 wt % support materials. The nitrided PtRu on a mesoporous carbon support provides enhanced hydrogen adsorbing capacity to accelerate the rate of oxidation of methanol at the anode of a direct methanol fuel cell, resulting in greater efficiency of the fuel cell.

### BACKGROUND OF THE INVENTION

1. Field of the Invention

The present invention relates to fuel cells, and particularly to a fuel cell membrane electrode assembly that provides high performance through improved catalytic reaction.

2. Description of the Related Art

Recent energy demands, increased environmental consciousness, and economic pressures have increased the outlook on alternative power sources. Conventional sources of energy and utilitarian power, such as fossil fuels and coal, are not limitless. They also produce tons of pollutants on an annual basis. As long as the demand exists, the more costly it becomes to meet those demands in the future, and the more negative impact they have on the environment.

One potential alternative power source lies in fuel cells. Fuel cells have widely been used for various purposes, such as backup power for residential, commercial and industrial buildings; a power source for remote locations, research facilities, weather stations and the like; spacecraft; industrial vehicles and more recently, commercial vehicles as a reaction to recent interests in viable electric vehicles, to name a few.

Fuel cells provide several advantages over conventional electric generators. For example, they do not require conventional fuels, such as fossil fuels, to facilitate the chemical reactions. A typical fuel cell may use oxygen and hydrogen, which are more abundant, as reactants. The quantity of any pollutants produced by such reactions is much less than combustion engines. Moreover, they are more efficient compared to combustion engines. Combustion engines may be energy efficient up to 25%, while fuel cells can theoretically reach 70% or more efficiency. Fuel cells have no moving parts, and they are relatively compact and lightweight, which together provides greater reliability and options for installation and application.

Fuel cells function much like batteries in that they provide a ready source of stored energy, but unlike batteries, fuel cells can store the energy for a greater length of time. Moreover, fuel cells will continuously generate electricity as long as the fuel cell is supplied with the requisite reactants. While such advantages exist, fuel cells generally are not as efficient in generating power in comparison with batteries, primarily due to inefficient oxygen reduction.

There has been tremendous interest during the last decade regarding research and development of a direct methanol fuel cell (DMFC). However, large-scale commercialization of DMFC is still hindered by some technical problems. One of the problems is poor performance of the membrane electrode assemblies (MEAs) due to low activity of the anode catalysts. Various research groups in many universities and research centers around the world have made serious efforts to fabricate high-performance MEAs using improved anode catalysts for the methanol electro-oxidation reaction. Compared to any single-metal catalyst, platinum (Pt) has shown the highest activity for the electro-oxidation of methanol in an acid environment. However, Pt is expensive, and during the methanol electro-oxidation reaction, adsorbed carbon monoxide (CO_{ads}) and other organic intermediates, such as formaldehyde, formic acid and methyl formate, are formed on the Pt surface, which results in poisoning of the Pt catalyst. Thus, there is a need to enhance the Pt catalysts in order to improve the rate of the methanol electro-oxidation reaction.

Various catalyst systems exist for the methanol electro-oxidation reaction. Most of these catalysts are based on modification of Pt with some other metal(s). The purpose of these catalyst systems is to accelerate the oxidation of the intermediates and decrease their accumulation so as to improve the catalyst performance, Among the various catalyst formulations, Pt—Ru alloy has shown the best results for methanol electro-oxidation. Following a hi-functional mechanism, the Ru—OH species act as a source of atomic oxygen, required for the oxidation of CO_{ads} to CO₂, thus liberating active sites on the surface of the catalyst material near a platinum atom. The reaction steps are described using a hi-functional mechanism as follows:

Pt+CH₃OHₛₒₗ→Pt−CO_{ads}+4H++4e⁻ (1)

Ru+H₂O→Ru−OH_{ads}+H⁺+e⁻ (2)

Pt−CO_{ads}+Ru−OH_{ads}→Pt+Ru+CO₂+H⁺+e⁻ (3)

In order to achieve high catalysts utilization, the PtRu metals are usually dispersed on a support material. Compared to bulk metal catalysts, supported catalysts normally exhibit higher performance. Carbon materials are mostly used as methanol electro-oxidation catalysts support because of their relative stability in both acidic and alkaline media, good electrical conductivity and high surface area.

In light of the above, it would be a benefit in the fuel cell art to provide a fuel cell catalyst membrane with a high rate of electro-oxidation reaction for improved performance. Thus, a fuel cell membrane electrode assembly solving the aforementioned problems is desired.

### SUMMARY OF THE INVENTION

The fuel cell membrane electrode assembly includes platinum-ruthenium (PtRu) active species supported on mesoporous carbon nitride materials for use in the anode of direct methanol fuel cells. The fuel cell membrane electrode assembly and variations thereof provide increased methanol electro-oxidation reaction performance compared to conventional catalysts having PtRu supported on multi-walled carbon nanotubes or Vulcan®XC-72. The composition of the fuel cell membrane electrode assembly is about 30 wt % active species and 70 wt % support materials. Testing of the fuel cell membrane electrode assemblies obtained results of up to about 58% power density gain over conventional catalysts.

These and other features of the present invention will become readily apparent upon further review of the following specification and drawings.

### BRIEF DESCRIPTION OF THE DRAWINGS

FIG. 1A is a graph showing low angle powder x-ray diffraction (XRD) patterns for synthesized mesoporous carbon nitride (MCN) materials of a fuel cell membrane electrode assembly according to the present invention.

FIG. 1B is a graph showing high-angle powder XRD patterns for the synthesized MCN material of the fuel cell membrane electrode assembly.

FIG. 2 is a graph showing FT-IR spectra comparing the spectra of conventional support materials and the synthesized MCN materials.

FIG. 3A is a graph showing N₂ sorption isotherms at different relative pressures for the support materials of FIG. 2.

FIG. 3B is a graph showing the N₂ pore size distribution for the support materials of FIG. 2 derived from the desorption branch of the N₂ hysteresis.

FIG. 4A is a graph showing high-angle powder XRD patterns for PtRu/MCN-100, PtRu/MCN-130, and PtRu/MCN-150 catalysts.

FIG. 4B is a graph showing high-angle powder XRD patterns for PtRu/Vulcan® XC-72 and PtRu/F-MWCNT catalysts.

FIG. 5 is a perspective view of a system used to measure electrochemical performance of the catalysts in FIGS. 4A and 4B.

FIG. 6 is a graph showing cyclic voltammogram curves for the catalysts of FIGS. 4A and 4B in 2.0M CH₃OH+1M H₂SO₄.

FIG. 7 is a graph showing variation in mass activity versus time for the catalysts of FIGS. 4A and 4B.

FIG. 8 is a perspective view of a fuel cell membrane electrode assembly according to the present invention.

FIG. 9 is a graph showing polarization curves for the MEA 1 catalyst.

FIG. 10 is a graph showing polarization curves for the MEA 6 catalyst.

FIG. 11 is a schematic drawing of a direct methanol fuel cell having a fuel cell membrane assembly according to the present invention at the anode.

Similar reference characters denote corresponding features consistently throughout the attached drawings.

### DETAILED DESCRIPTION OF THE PREFERRED EMBODIMENTS

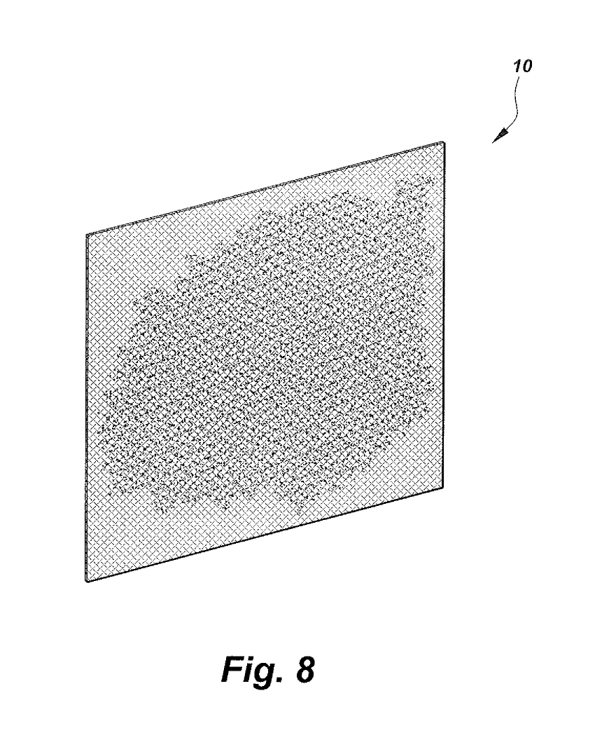

The fuel cell membrane electrode assembly or fuel cell MEA, generally referred to in the drawings by the reference number 10 and exemplarily shown in FIG. 8, is constructed from various synthesized mesoporous carbon nitride (MCN) supports that provide higher fuel cell catalyst performance.

The type of carbon material used in preparing a catalyst has a strong influence on its properties (such as metal particle-size, dispersion, morphology, alloyed degree, etc.) and performance (activity and stability). This highlights the choice of an appropriate carbon support in preparing the methanol electro-oxidation catalysts for use in the anode of the DMFC. The required properties of a support material for the preparation of an excellent electro-catalyst include sufficiently high surface area, reasonable porosity, suitable surface functional groups, right morphology, good electronic conductivity, high corrosion resistance, and low-cost. Among these factors, specific surface area has a significant effect on the preparation and performance of supported catalysts.

Conventional support materials, such as Vulcan® XC-72 (an industry standard conductive carbon black produced by Cabot Corporation) and carbon nanotubes, have been used by others in the preparation of catalysts for the methanol electro-oxidation reaction. However, they have relatively small surface area. In contrast, the fuel cell electrode assembly 10 described herein includes high surface area MCN materials synthesized using SBA-15, a known mesoporous silica, as a template with different aging temperatures of 100, 130, and 150° C. The synthesized MCN materials are used as support to prepare nitrided PtRu catalysts, which, in turn, are used as anode catalysts in the fabrication of the fuel cell MEA 10. The fuel cell MEA 10 exhibited improved catalytic activity for the methanol electro-oxidation reaction over the conventional PtRu alloy catalysts supported on the conventional Vulcan® XC-72 and functionalized multi-walled carbon nanotubes (F-MWCNTs). The inventors believe that nitriding enhances the activity of platinum and ruthenium to adsorb hydrogen at the anode, and consequently results in a greater rate of reaction at the anode than with a mesoporous carbon support in which the PtRu is without nitriding. The characterization of the support materials and the prepared catalysts are shown in the graphs mentioned herein where BET surface area, FT-IR and XRD were used for the characterization. The performance evaluation for the various catalyst systems was conducted using cyclic voltammetry and practical DMFC. The catalyst systems contain about 30 wt % PtRu (1:1 molar ratio) and about 70 wt % support materials.

The following describes construction of the various embodiments of the fuel cell MEA 10 and the results thereof.

As mentioned above, SBA-15 was used as the template for preparing the MCN. The SBA-15 was synthesized by dispersing 4 g of Pluronic P123 (a tri-block copolymer—EO₂₀PO₇₀EO₂₀—(poly (ethylene glycol)—block-poly (propylene glycol)—block poly (ethylene glycol)), which serves as the structure-directing agent, into 30 g of distilled water and stirred for 4 hrs at room temperature. Then, 120 ml of 2M hydrochloric acid (HCl) solution was added and stirred at 40° C. for 2 hrs. This is then followed by addition of 9 g tetraethylorthosilicate and continuous stirring for 24 hrs at 40° C. The resulting gel was aged (three samples at 100° C., 130° C. and 150° C.), after which it was filtered, washed with deionized water several times, and dried in an oven at 100° C. overnight. Finally, the powder was calcined at 540° C. for 24 hrs to obtain the SBA-15. The prepared SBA-15 samples were labeled SBA-15 (100° C.), SBA-15 (130° C.), and SBA-15 (150° C.) and were used as templates for the preparation of mesoporous carbon nitride, labeled as MCN-100, MCN-130 and MCN-150. For the preparation of the MCN materials, 1 g of SBA-15 sample was added to a mixture of 2.7 g ethylene diamine (EDA) and 6 g carbon tetrachloride (CTC). The resulting mixture was refluxed and stirred at 90° C. for 6 hrs. Then, the obtained dark-brown solid mixture was placed in a drying oven for 12 hrs, and grounded into powder. The resulting fine powder was placed in a furnace at 600° C. for 5 hrs under nitrogen flow to obtain a black fine powder. The MCN samples were recovered after dissolution of the silica framework in 5 wt % hydrofluoric acid (HF), by filtration and washing several times with ethanol and dried at 100° C. for 6 hrs.

The synthesized MCN materials, commercial multi-walled carbon nanotubes (MWCNTs) and Vulcan® XC-72 were used as the support materials for different catalyst samples prepared using a combined process of precipitation and co-impregnation methods. However, the commercial MWCNTs were initially functionalized using conventional acid treatment. The raw MWCNTs were immersed in a solution of 30% HNO₃ and 98% H₂SO₄ and refluxed at 80° C. for 10 hrs. The suspension was filtered, washed copiously with distilled water and dried at 100° C. overnight to obtain the functionalized MWCNTs powder. The support material (MCN, MWCNTs, or Vulcan®), hydrogen hexachloroplatinate (IV) hexahydrate (H₂PtCl₆.6H₂O), and ruthenium (III) nitrosyl nitrate solution (Ru (NO) (NO₃)ₓ (OH)_{y}) were dispersed in ethanol. The mixture was dried at room temperature in N₂ flow. The dried powder was reduced at 400° C. for 2 hrs in a mixture of H₂ (10%) and He (90%) flow.

The activity of the prepared catalyst systems were tested for the methanol electro-oxidation reaction using cyclic voltammetry in an electrochemical cell experiment. Due to the promising results obtained, the prepared catalyst systems were then used as anode catalysts in the fabrication of MEAs.

In order to prepare the fuel cell MEA 10, commercial Nafion® 117 membrane, an industrial catalyst membrane manufactured by E. I. du Pont de Nemours and Company, was obtained and pre-treated to exchange the Na⁺ cations with H⁺ ions in the membrane. For the catalyst slurry, catalyst loading of 3 mg cm⁻² and 1 mg cm⁻² for the anode (the prepared catalyst samples to be tested) and cathode (Pt/C) were used, respectively. The prepared catalyst slurries were then coated on both the membrane and gas diffusion layers (carbon cloth) and sandwiched together. After drying, the fuel cell MEAs were hot-pressed in a Carver® Press at 130° C. and 1000 psi for 5 minutes.

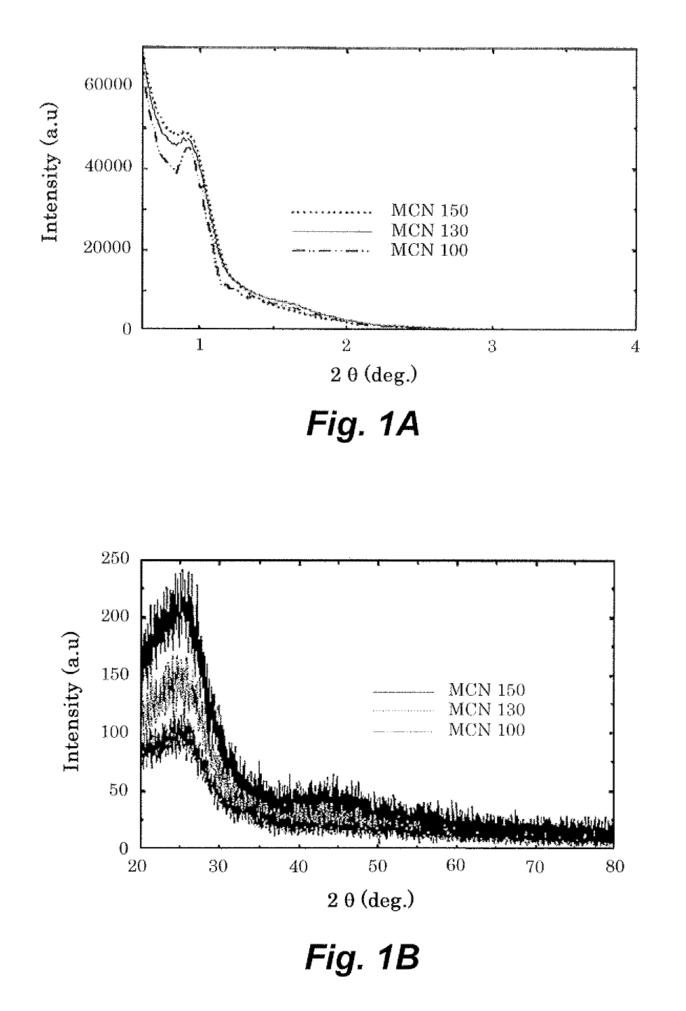

Powder X-ray diffraction (XRD) patterns for the synthesized MCN materials, Vulcan® XC-72, and MWCNTs are shown in FIGS. 1A and 1B. The low angle XRD patterns obtained for the synthesized MCN materials (FIG. 1A) are similar to those of pure siliceous SBA-15 materials, indicating that the framework structure of the SBA-15 is well maintained so that the mesoporous carbon nitride is an ordered support. The diffraction peaks can be observed at the 20 of 1.0° and 1.7° (though not sharp), which can be indexed to the (100) and (110) of the hexagonal P6mm space group respectively. In the higher angle XRD (FIG. 1B), two broad diffraction peaks appeared near 2θ of 25.0° and 45.0°. These peaks are generally attributed to the presence of carbon material, especially the peak at 2θ of 25.0°. Thus, it is confirmed that all the prepared MCN are carbon materials.

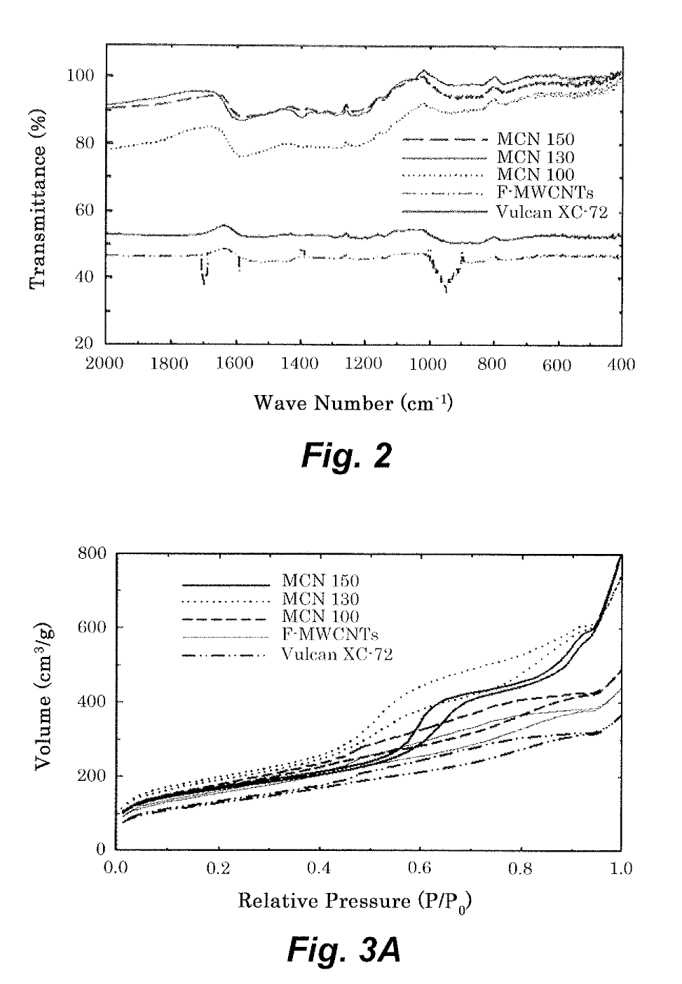

FIG. 2 shows the FT-IR spectra obtained for the support materials. Several peaks can be observed that represent different functional groups. The broad peak at 1480-1580 cm⁻¹ is important in characterizing the chemical state of N and is assigned to N—H vibrations of the NH₂ group. This implies that the NH₂ groups exist on the MCN surface, which would be beneficial for the deposition of the PtRu particles. In comparison with other samples, much stronger absorption bands were found at 900-1050 cm⁻¹ for the F-MWCNTs, which indicates that a high density of surface functional groups, such as C—OH and —C═O, are created on the surface of the F-MWCNTs. In addition, the peak near 1700 cm⁻¹ suggests that carboxylic acid groups were attached on the surface of the F-MWCNTs. The type and quantity of functional groups attached to a support material have significant influence on the suitability of the material for use as a support for the preparation of methanol electro-oxidation catalysts. This is because the type of functional groups available in a support material affects the degree of metal active specie(s) affection to it, and the availability of more functional groups implies more space where the active metal specie can be anchored.

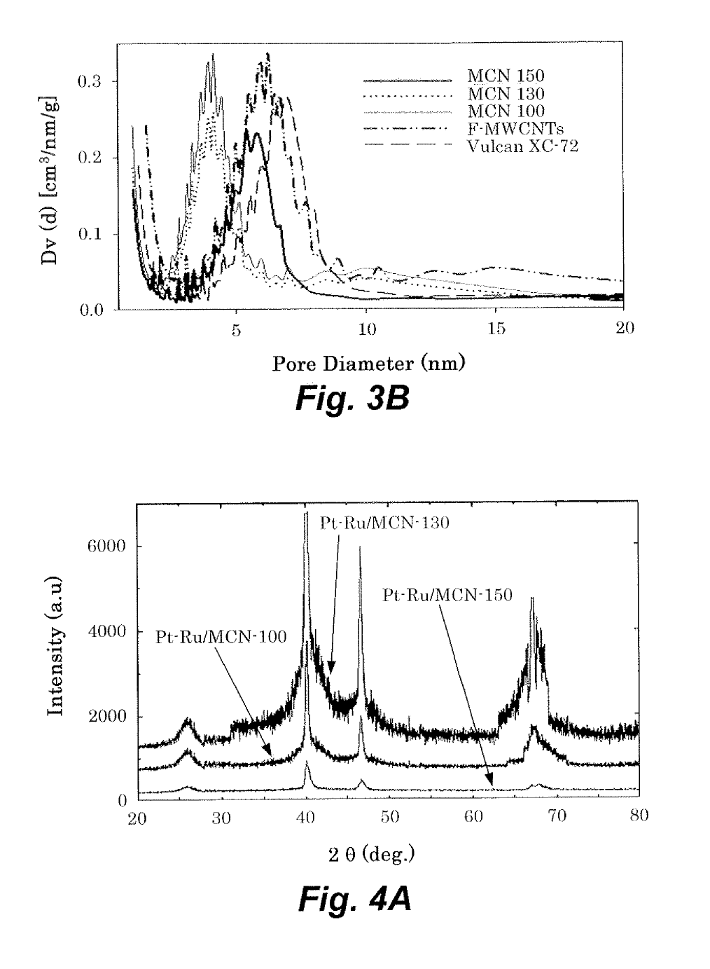

The results of specific surface area and porosity of the Vulcan® XC-72, MWCNTs, and the synthesized MCN are shown in FIGS. 3A-3B and Table 1. In FIG. 3A, all the isotherms for the MCN materials show a typical Type IV model according to the IUPAC classification and have a H1 hysteresis loop at the high pressure side that is representative of mesopores. The Type IV adsorption isotherm characterizes the existence of mesoporosity of the MCN samples, which plays an important role in dispersing the metal active species. The shape of the N₂ adsorption-desorption isotherms further confirms that a well-ordered mesoporous structure was obtained for the MCN materials. The sharp inflections between the relative pressures (P/P₀) 0.45-0.85 in the isotherms, especially for the MCN-130 and MCN-150 samples, correspond to capillary condensation within the uniform mesopores. The sharpness of the inflection step demonstrates the extent of uniform pore size distribution in the MCN samples. The textural parameters such as the specific surface area, pore volume and pore diameter are given in Table 1. The pore size distribution derived from desorption branch of the N₂ hysteresis for the MCN samples is shown in FIG. 3B. The well-known BJH method was used to analyze the desorption branch of the isotherms at relatively high pressure to obtain the pore size distribution of the support samples. The presence of mesopores is expected to enhance deposition of the metal active species because molecules within microporous channels could suffer significantly hindered transport, while molecules in mesoporous channels can approach diffusion rates comparable to those in an open medium.

TABLE 1
Pore Structure for the Support Materials

| Support | BET Surface Area | Total Pore | Average Pore |
|---|---|---|---|
| Material | (m² g⁻¹) | Volume (cm³ g⁻¹) | Diameter (nm) |
| MCN-100 | 630 | 0.95 | 5.9 |
| MCN-130 | 688 | 0.96 | 4.3 |
| MCN-150 | 597 | 0.87 | 6.4 |
| F - MWCNTs | 255 | 0.63 | 6.7 |
| Vulcan XC 72 | 230 | 0.57 | 6.8 |

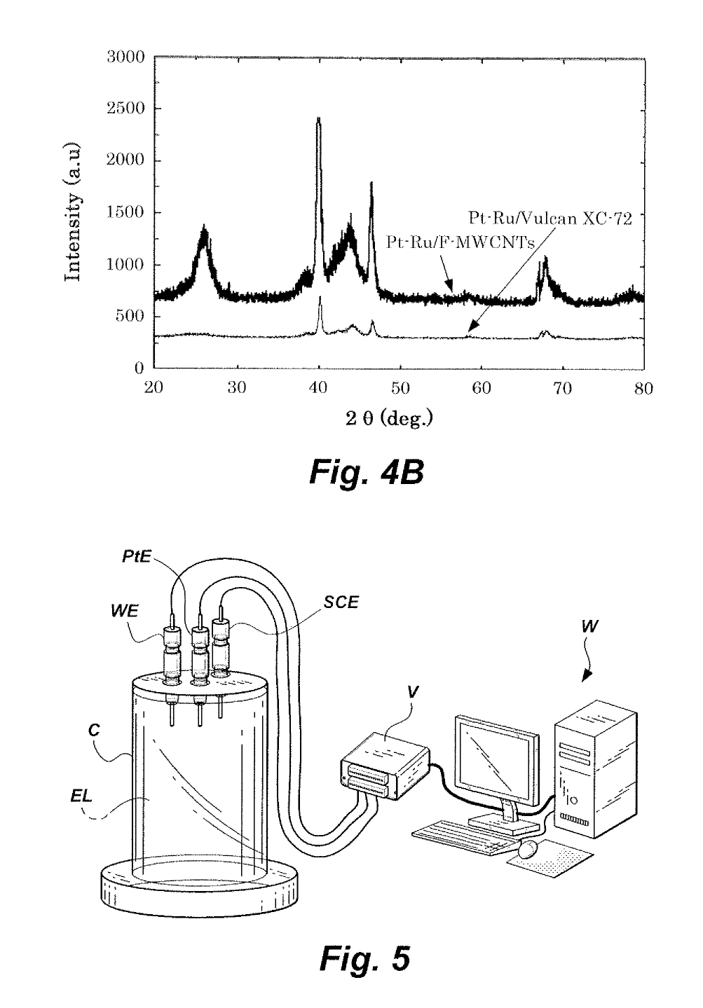

FIGS. 4A and 4B show the high-angle powder XRD patterns for the prepared catalyst samples. In all the samples, the presence of the face-centered cubic (fee) structure typical of platinum metal could be inferred from the strong diffractions represented by the crystalline planes (111), (200), and (220), near 2θ of 40.0°, 46.0°, and 68.0° respectively. As mentioned earlier, the peak at 2θ of 25.0° is mainly due to the carbon support. Comparison of the peaks intensity reveals that the Pt—Ru/MCN-100, Pt—Ru/MCN-130 and Pt—Ru/MCN-150 samples (FIG. 4A) showed high intensity relative to the Pt—Ru/Vulcan XC- 72 and Pt—Ru/F-MWCNTs samples (FIG. 4B), which suggests better crystallinity in the Pt—Ru/MCN-100, Pt—Ru/Mcn-130 and Pt—Ru/MCN-150 samples. In the course of the catalysts reduction with hydrogen, three scenarios are possible: (1) Ru segregates into a separate phase and forms monometallic nanoparticles, (2) Ru metal is segregated onto the surfaces of alloy particles, or (3) bimetallic RuM alloy particles are formed. In the present case, the XRD patterns for the Pt—Ru/Vulcan® XC-72 and Pt—Ru/F-MWCNTs catalyst samples (FIG. 4B) show the (101) and (102) Ru reflections near 44.0° and 58.0°; 2θ, which illustrates that Ru is segregated in a separate phase.

However, Ru promotes the dispersion of the electro-catalyst, i.e., the unalloyed amorphous material that may reside on or near the surface of the PtRu alloy particles may help prevent sintering during the deposition or during the thermal reduction processes. This is one of the reasons why smaller particle size for Pt—Ru/Vulcan® XC-72, as compared with the Pt/Vulcan® XC-72 catalyst, is normally observed. In the Pt—Ru/MCN-100, Pt—Ru/MCN-130 and Pt—Ru/MCN-150 catalyst samples, peaks associated with metallic :Ru were not observed. The metallic Ru is contained in bimetallic (PtRu) alloy nanoparticles. The average PtRu crystal size was calculated using the Debye-Scherrer's equation.

$$D = \frac{K {λ}_{CuK α}}{{B}_{2 θ} cos {θ}_{max}} \qquad ( 4 )$$

where D is the crystal size, K is the shape factor (0.9), λ_{CuKα} is the K radiation from Cu (1.54056 Å), B_{2θ} is the full width at half maximum (corrected value, taking into account instrument contribution), and θₘₐₓ is the angle at maximum peak.

The d-spacing and lattice parameter were determined using the Bragg's equation and the relationship between d-spacing and lattice parameter for cubic systems respectively:

$$\begin{matrix}{d}_{hkl} = \frac{λ}{2 sin θ} & ( 5 ) \\ \frac{1}{{( {d}_{hkl} )}^{2}} = \frac{{h}^{2} + {k}^{2} + {l}^{2}}{{a}^{2}} & ( 6 )\end{matrix}$$

where dₕₖₗ is the d-spacing (Å), h, k, and l are the miller indices, and a is the lattice parameter

In order to determine the PtRu crystal size, the (220) reflection was used because even though it is not the strongest, it is completely outside the region of the broad band produced by the carbon support, thus there is no overlap. Average PtRu particle size and lattice parameter for the prepared catalyst samples are given in Table 2. From Table 2, it can be seen that Pt—Ru/MCN-130 showed the least PtRu crystal size of 1.7 nm, which is desirable for good dispersion while Pt—Ru/Vulcan® XC-72 showed the highest PtRu crystal size of 2.5 nm. In terms of lattice parameter, the Pt—Ru/MCN-130 showed the highest value of 3.8962 Å while Pt—Ru/Vulcan® XC-72 showed the least value of 3.8662 Å. In general, it can be observed that the MCN supported catalyst samples showed lower PtRu crystal size and higher lattice parameter (inter-distance between PtRu to PtRu particles). This indicates that the MCN support materials allow better dispersion of the PtRu particles, which prevents the coalescence of the growing nuclei. However, it should be mentioned that when the surface area of a support material is too large, it can result into a situation where the PtRu particles are scattered too far apart, which will negatively affect the catalyst performance.

TABLE 2
XRD Data Analysis for the Prepared Catalyst Samples

| | | | Lattice Parameter |
|---|---|---|---|
| Catalyst Sample | Crystal Size (nm) | dₕₖₗ (Å) | (Å) (a) |
| Pt—Ru/Vulcan XC-72 | 2.5 | 1.3669 | 3.8662 |
| Pt—Ru/F-MWCNTs | 2.2 | 1.3704 | 3.8761 |
| Pt—Ru/MCN-100 | 2.0 | 1.3739 | 3.8860 |
| Pt—Ru/MCN-130 | 1.7 | 1.3775 | 3.8962 |
| Pt—Ru/MCN-150 | 2.1 | 1.3722 | 3.8812 |

The catalytic activities of the prepared catalyst samples for methanol electro-oxidation were measured using the cyclic voltammetry technique. As exemplarily shown in FIG. 5, a three-electrode cell C was employed for the electrochemical test using an AUTOLAB Potentiostat (PGSTAT-30 GPES software) installed in a workstation W. The working electrode WE was fabricated by coating a copper electrode with Nafion-impregnated catalysts slurry. The catalyst slurry was prepared by mixing the catalysts powder with distilled water and 5 wt % Nation solution, followed by sonication. After coating onto the copper electrode, the electrode was dried for 90 min at 60° C. The metals (PtRu) loading for all the working electrodes was kept the same ˜4.45 mg/cm². A Pt wire electrode PtE and a saturated calomel electrode SCE were used as the counter and reference electrode respectively. The electrolyte solution EL was 1M H₂SO₄, which was thoroughly purged with N₂. The methanol electro-oxidation activity was measured using CV in 2M CH₃OH+1M H₂SO₄. All the measurements were conducted at 22° C.

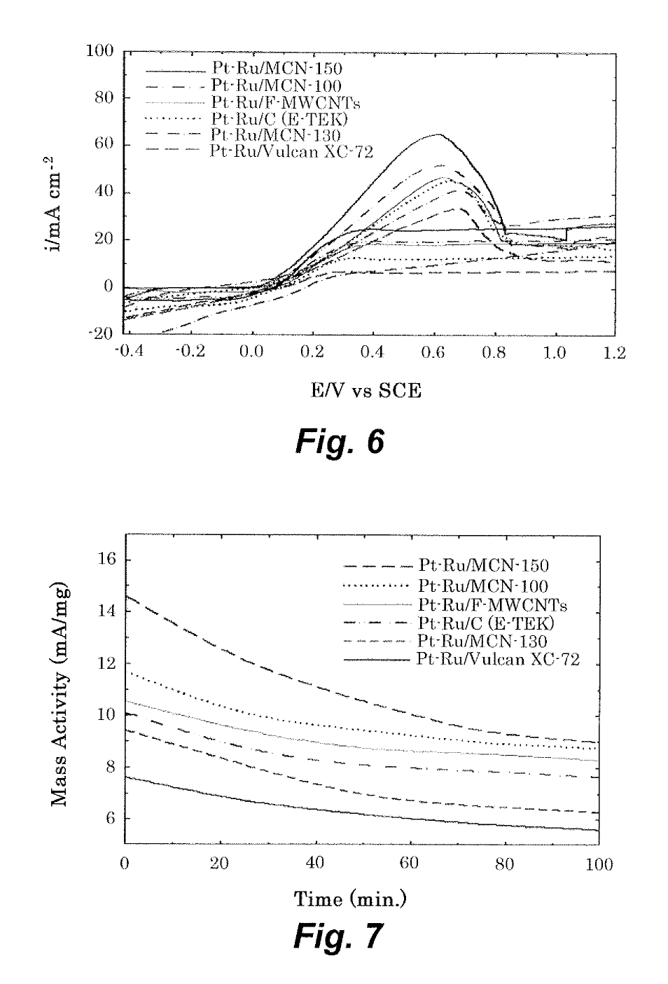

FIG. 6 shows the cyclic voltammetry results of methanol electro-oxidation activity for the prepared catalyst samples and commercial Pt—Ru/C (E-TEK) measured in deaerated 1M H₂SO₄+2M CH₃OH solution. The anodic peaks for methanol electro-oxidation are clearly observed for all the catalyst samples between 0.62-0.69 V. Highest methanol electro-oxidation peak is observed for the Pt—Ru/MCN-150. As shown in Table 3, Pt—Ru/MCN-150, Pt—Ru/MCN-100 and Pt—Ru/F-MWCNTs showed higher activity compared to the commercial Pt—Ru/C (E-TEK). In addition, these catalyst samples exhibit low onset potential for methanol electro-oxidation than the commercial Pt—Ru/C (E-TEK), which further confirms their superior methanol electro-oxidation.

However, Pt—Ru/MCN-130 showed a slightly lower activity than the commercial Pt—Ru/C (E-TEK) even though it has the lowest PtRu crystal size, and the MCN-130 support material showed the largest surface area, which usually enhances better dispersion of the metal species. Its lower activity is believed to be partly due to the largest surface area of the MCN-130 support material, which gave the lowest pore diameter, lowest difference between the PtRu crystal size and the support pore diameter of 2.6 nm and the highest inter-distance between the PtRu-PtRu particles. When the difference between the support pore diameter and the metal crystal size is low, the metal species may find it difficult to freely move into the pores of the support material. In addition, large surface area may result in the metal active species being dispersed too far apart. Thus, an optimum surface area is required for enhanced activity.

With respect to the Pt—Ru/F-MWCNTs, it was expected that PtRu catalyst supported on carbon nanotubes would exhibit enhanced activity compared to the commercial Pt—Ru/C (E-TEK). However, as seen in Table 3, the commercial Pt—Ru/C (E-TEK) showed better activity compared to the Pt—Ru/Vulcan® XC-72 as prepared. This suggests that apart from the type of support material, method of preparation also affects a catalyst activity.

TABLE 3
Cyclic Voltammetry Results for Catalyst Samples and E-TEK

| | | Current | Mass |
|---|---|---|---|
| | Peak Position | Density | Activity |
| Catalyst Sample | V vs SCE | (mA/cm⁻²) | (mA/mg) |
| Pt—Ru/MCN 150 | 0.62 | 65 | 14.61 |
| Pt—Ru/MCN 100 | 0.63 | 52 | 11.69 |
| Pt—Ru/F-MWCNTs | 0.65 | 47 | 10.56 |
| Pt—Ru/C (E-TEK) | 0.66 | 45 | 10.11 |
| Pt—Ru/MCN 130 | 0.68 | 42 | 9.44 |
| Pt—Ru/Vulcan XC - | 0.69 | 34 | 7.64 |
| 72 | | | |

In addition to the methanol electro-oxidation activity, preliminary stability testing was also carried out, as shown in FIG. 7. A relatively fast decay was observed for the Pt—Ru/MCN-150 catalyst sample. This is attributed to the high activity of the Pt—Ru/MCN-150 catalyst, which leads to rapid production of the intermediates, such as the CO_{ads}, during the methanol electro-oxidation. If the kinetics of the removal of the intermediates cannot keep pace with that of methanol electro-oxidation, then a fast decay will occur. The catalysts mass activity decreased by 21.3%, 24.43%, 25.1%, 26.4%, 33.4% and 38.5% from its initial value for the Pt—Ru/F-MWCNTs, commercial Pt—Ru/C (E-TEK), Pt—Ru/MCN-100, Pt—Ru/Vulcan XC 72, Pt—Ru/MCN-130 and Pt—Ru/MCN-150 respectively. In general, a reasonable stability was achieved after about 1 hr 30 min for all the catalyst samples during the methanol electro-oxidation.

Based on the cyclic voltammetry results, the prepared catalyst samples were used to fabricate MEAs. The MEA samples are labeled B1-B6 and include the following:

TABLE 4
Composition of MEA Samples

| Sample | Composition |
|---|---|
| B1: | Pt—Ru/MCN-150, Pt/C, GDLs on Nafion ® 117 Membrane |
| B2: | Pt—Ru/MCN-130, Pt/C, GDLs on Nafion ® 117 Membrane |
| B3: | Pt—Ru/MCN-100, Pt/C, GDLs on Nafion ® 117 Membrane |
| B4: | Pt—Ru/F-MWCNTs, Pt/C, GDLs on Nafion ® 117 Membrane |
| B5: | Pt—Ru/Vulcan-XC, Pt/C, GDLs on Nafion ® 117 Membrane |
| B6: | Pt—Ru/C (E-TEK), Pt/C, GDLs on Nafion ® 117 Membrane |

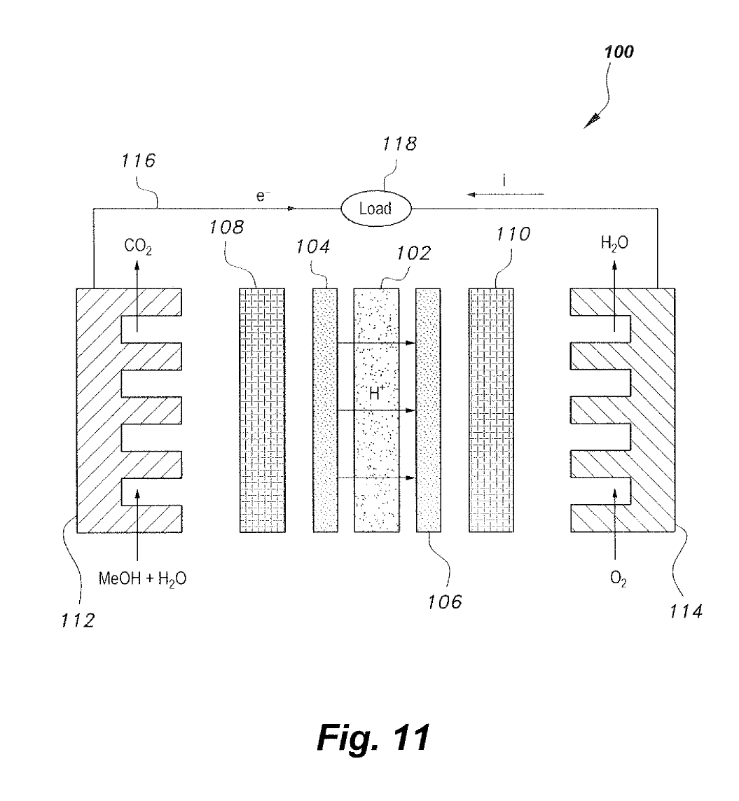

In Table 4, the first component of the composition is the anode catalyst, the second component (Pt/C) is the cathode catalyst, Nafion 117 is the polyelectrolyte membrane (PEM), and GDLs are the gas diffusion layers, e.g., carbon cloth. As shown in FIG. 11, in a direct methanol fuel cell 100, the flat Nafion membrane 102 forms the central core of the MEA. The anode catalyst 104 is disposed on the anode side of the membrane 102, and the cathode catalyst 106 is disposed on the cathode side of the membrane 102. A gas diffusion layer is placed next, outside each catalyst. Finally, an anode plate 112 is placed outside the GDL 108 on the anode side, and a cathode plate 114 is placed outside the GDL 110 on the cathode side. Methanol is oxidized by water at the anode to form carbon dioxide, protons (hydrogen ions) and electrons. The protons and electrons react with oxygen at the cathode to form water. The electrons are transported from the anode to the cathode by an external wire 116, the current being used to provide power to a load 118. The protons are transported from the anode to the cathode through the membrane 102. The catalysts speed up the rate of the oxidation and reduction reactions at the respective electrodes. Nafion is a sulfonated tetrafluoroethylene-based polymer or co-polymer having ionic properties that permit the transport of protons through the membrane 102, as well as good thermal and mechanical properties. its use in PEM.s is well known.

The MEAs were tested in a practical ARBIN Fuel Cell Test Station. The test conditions are:

TABLE 5
Sample Test Conditions

| Cell Temperature: | 70° C. & 80° C. |
|---|---|
| Cell Pressure: | Atmospheric |
| Methanol Concentration: | 2M |
| Methanol flow rate: | 2 ml/min |
| Oxygen flow rate: | 160 ml/min) |
| Air Humidification Temperature: | 80° C. |
| Applied Voltage: | 0-1 |

As shown in Table 6, the Pt—Ru/MCN-150 showed the highest power density, which is consistent with the cyclic voltammetry test results. As mentioned earlier, this is attributed to the suitable surface area and pore diameter of the MCN-150 support material of about 600 m²/g and 6.4 nm respectively. In addition, among the catalysts samples, Pt—Ru/MCN-150 catalysts showed moderate PtRu crystal size and lattice parameter of 2.1 nm and 3.8812 Å, respectively. This results in excellent dispersion of the active metal species (Pt—Ru). It is mostly agreed that the catalytic activity is strongly dependent on the shape, size and distribution of the active metal(s) particles. Thus, the extent of dispersion of the Pt particles in the catalysts significantly affects the performance of the catalysts. However, Pt—Ru/Vulcan XC-72, as prepared, showed the lowest power density, which suggests that the Vulcan® carbon support does not perform as well as the multi-walled carbon nanotubes and the mesoporous carbon materials.

TABLE 6
Power Density for MEAs

Power Density mW/cm²

| Sample | 70° C. | 80° C. |
|---|---|---|
| MEA 1: Pt—Ru/MCN-150 | 41.4 | 56.3 |
| MEA 2: Pt—Ru/MCN-130 | 37.8 | 43.49 |
| MEA 3: Pt—Ru/MCN-100 | 38.0 | 53.8 |
| MEA 4: Pt—Ru/F-MWCNTs | 24.97 | 29.3 |
| MEA 5: Pt—Ru/Vulcan XC - 72 | 21.0 | 23.0 |
| MEA 6: Pt—Ru/C (Commercial) | 21.9 | 23.59 |

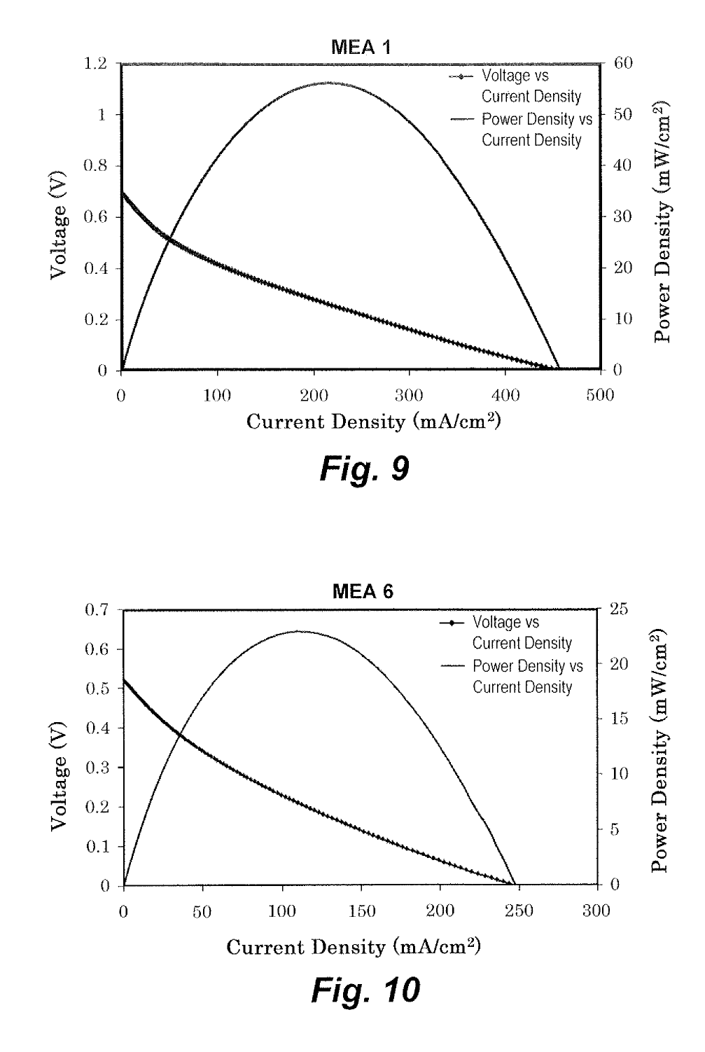

FIGS. 9 and 10 show polarization curves for the MEA 1 and MEA 6 at 80° C. respectively, including the maximum power density, which also clearly shows the superiority of the catalysts prepared using the MCN support materials. In most of the experimental and theoretical studies on direct methanol fuel cells, the polarization of the anode has been considered negligible unless the operating current density is high enough so that mass transport polarization effects arise on the anode.

Thus, the above results show that the fuel cell MEA 10 can be used in DMFC with a high degree of methanol electro-oxidation reaction. The performance gains in the fuel cell MEA 10 over conventional catalysts results in a more viable, large-scale commercialization of DMFC with minimal impact to the environment and strain on the current energy resources.

It is to be understood that the present invention is not limited to the embodiments described above, but encompasses any and all embodiments within the scope of the following claims.

We claim:

1. A catalyst for use in an anode fuel cell membrane electrode assembly in a direct methanol fuel cell, comprising:
a catalyst support constructed from mesoporous carbon nitride (MCN) material and having a surface; and
PtRu active species supported on the surface of the catalyst support,
wherein the porosity of the MCN material provides enhanced deposition of the PtRu active species, thereby increasing methanol electro-oxidation reaction rate at the anode of the fuel cell.

2. The catalyst according to claim 1, wherein said MCN material comprises an average pore diameter of about 4.3-6.4 nm.

3. The catalyst according to claim 1, wherein said catalyst support comprises a surface area of about 597-688 m²/g.

4. The catalyst according to claim 1, wherein said MCN material comprises a pore volume of about 0.87-0.96 cm³/g.

5. The catalyst according to claim 1, wherein the catalyst comprises about 25-35 wt % PtRu active species in a PtRu molar ratio of 1:1, the balance being MCN material.

6. The catalyst according to claim 5, wherein the catalyst comprises about 30 wt % PtRu active species, the balance being MCN material.

7. The catalyst according to claim 1, wherein said PtRu active species has a crystallite size of about 1.7-2.1 nm.

8. The catalyst according to claim 1, wherein the catalyst has a lattice parameter of about 3.8860-3.8962 Å.

9. The catalyst according to claim 1, wherein the catalyst has a mass activity of about 9.44 -14.61 mA/mg.

10. A fuel cell membrane electrode assembly for an anode of a direct methanol fuel cell, comprising:
an anode plate;
a gas diffusion layer adjacent the anode plate; and
a catalyst adjacent the gas diffusion layer, the catalyst including:
a catalyst support constructed from an ordered mesoporous carbon nitride (MCN) material; and
platinum and ruthenium disposed on the catalyst support.

11. The fuel cell membrane electrode assembly according to claim 10, wherein the fuel cell membrane electrode assembly has a power density of about 37.8-41.4 mW/cm² at 70° C.

12. The fuel cell membrane electrode assembly according to claim 10, wherein the fuel cell membrane electrode assembly has a power density of about 43.49-56.3 mW/cm² at 80° C.

13. The fuel cell membrane electrode assembly according to claim 10, wherein said gas diffusion layer comprises carbon cloth.

14. The fuel cell membrane electrode assembly according to claim 10, wherein said mesoporous carbon nitride catalyst support is formed on an SBA-15 template.

15. The fuel cell membrane electrode assembly according to claim 10, wherein said mesoporous carbon nitride catalyst support has an average pore diameter of about 4.3-6.4 nm, a surface area of about 597-688 m²/g, and a pore volume in the range of about 0.87-0.96 cm³/g.

16. The fuel cell membrane electrode assembly according to claim 10, wherein said catalyst comprises about 25-35 wt % PtRu active species in a PtRu molar ratio of 1:1, the balance being MCN material.

17. A direct methanol fuel cell, comprising:
a polyelectrolyte membrane having opposite sides;
an anode catalyst disposed on one side of the membrane, the catalyst including:
a catalyst support constructed from an ordered mesoporous carbon nitride (MCN) material on an SBA-15 template; and
platinum and ruthenium disposed on the catalyst support;
a cathode catalyst disposed on the side of the membrane opposite the anode catalyst, the cathode catalyst being a Pt/C catalyst;
a first gas diffusion layer disposed adjacent the anode catalyst and a second gas diffusion layer disposed adjacent the cathode catalyst;
an anode plate disposed adjacent the first gas diffusion layer; and
a cathode plate disposed adjacent the second gas diffusion layer.

18. The direct methanol fuel cell according to claim 17, wherein said anode catalyst comprises about 25-35 wt % PtRu active species in a PtRu molar ratio of 1:1, the balance being MCN material.

19. The direct methanol fuel cell according to claim 17, wherein said mesoporous carbon nitride catalyst support has an average pore diameter of about 4.3-6.4 nm, a surface area of about 597-688 m²/g, and a pore volume in the range of about 0.87-0.96 cm³/g.

20. The direct methanol fuel cell according to claim 17, wherein said gas diffusion layers comprise carbon cloth.
